(19) United States
(12) Patent Application Publication
(10) Pub. No.: US 2014/0140579 A1
(43) Pub. Date: May 22, 2014

(54) IMAGE PROCESSING APPARATUS CAPABLE OF GENERATING OBJECT DISTANCE DATA, IMAGE PROCESSING METHOD, AND STORAGE MEDIUM

(71) Applicant: CANON KABUSHIKI KAISHA, Tokyo (JP)

(72) Inventor: Kazuki Takemoto, Kawasaki-shi (JP)

(21) Appl. No.: 14/086,401

(22) Filed: Nov. 21, 2013

(30) Foreign Application Priority Data
Nov. 22, 2012 (JP) 2012-256463

(51) Int. Cl. G01C 3/08; G06T 7/00

(52) U.S. Cl. CPC G01C 3/08; G06T 7/00
USPC 382/106

(57) ABSTRACT

An image processing apparatus includes a distance measuring unit configured to measure a distance from a target object and generate a distance image, a camera configured to acquire a captured image including the target object, a reliability calculating unit configured to calculate a reliability level with respect to a measurement value of the generated distance image based on the captured image and the distance image and generate a reliability image, and distance data correcting unit configured to generate a high reliability distance image using the reliability image and the distance image and generate a corrected distance image by interpolating or extrapolating the high reliability distance image up to a region including a contour line.

### BACKGROUND OF THE INVENTION

1. Field of the Invention

The present invention relates to an image processing apparatus, an image processing method, and a storage medium, which are usable to measure the distance from an object and generate a display image.

2. Description of the Related Art

A conventionally known time-of-flight (TOF) distance measurement system is configured to emit a light beam (e.g., infrared ray) toward a target object and measure the amount of time required for returning the light beam reflected by the target object to measure the distance between the target object and the apparatus itself. There is a TOF type distance sensor configured to operate according to the above-mentioned distance measuring method.

More specifically, the TOF type distance sensor detects a phase difference between the emitted light beam and the reflected light beam and measures the distance from a target object based on the detected phase difference. For example, as discussed in Japanese Unexamined Patent Application Publication (Translation of PCT Application) No. 10-508736, the TOF type distance sensor is configured to measure the intensity of emitted light four times a period and measure the distance based on a phase difference between the detected light signal and the emitted modulation signal.

Further, the distance sensor may be configured to include a two-dimensionally arranged sensor array to perform the above-mentioned distance measurement at respective sensing portions simultaneously, according to which the distance data is processed successively at the speed of 12 Hz to 29 Hz and a distance image having a resolution of 176×144 can be output.

However, the design of TOF type distance sensor is based on the assumption that the target object is stationary. Therefore, if the target object is moving, the distance measurement value of the target object includes a large error. More specifically, the distance sensor performs a plurality of samplings at different timings in a process of measuring the distance, to determine a final distance value. Therefore, a deformed light signal is possibly detected when the target object is moving at a higher speed. Accurately obtaining the phase difference between the detected light signal and the emitted modulation signal is difficult.

An example state where a distance measurement apparatus measures the distance from a human hand 402L illustrated in FIG. 9 is described below. FIG. 10 schematically illustrates a display result of a three-dimensional polygon mesh 1010 that can be generated based on distance data acquirable by measuring the distance from the hand 402L in a state where the distance measurement apparatus and the hand 402L are stationary. As mentioned above, in a state where the measurement target is stationary, it is feasible to assure comparatively higher accuracy in the measurement of the distance. However, if the hand 402L (i.e., the target object) starts moving, a large measurement error tends to occur in a contour region.

FIG. 11 schematically illustrates a display result of the three-dimensional polygon mesh 1010 obtainable when the distance from the hand 402L is measured in a state where the hand 402L is moving from the right to the left. FIG. 12 schematically illustrates a cross section 1110 of the hand 402L illustrated in FIG. 11, which can be seen from the horizontal direction. As illustrated in FIGS. 11 and 12, the distance measurement value at a contour positioned in the travelling direction tends to include a larger measurement error on the front side of the distance measurement apparatus.

In a contour area on the opposite side in the travelling direction, the measurement error becomes greater at the inner side of the distance measurement apparatus. The reason why the error becomes greater at the contour region is because the signal in the contour region of the moving target object is an integration of a correct signal resulting from the reflection of light on the target object and an error signal resulting from the reflection of light on a place other than the target object, when the distance measurement apparatus performs a plurality of samplings at different timings in a process of measuring the distance.

More specifically, when the distance measurement apparatus measures a phase difference between the emitted light signal and the received light signal, a large distance measurement error is detected if the received light signal is erroneous. Further, due to a similar reason, accurately obtaining the phase difference is difficult when the distance measurement apparatus itself is moving. Therefore, in a situation where the apparatus itself is attached to a human body, a large measurement error occurs each time the apparatus moves together with the human body

Further, according to the TOF-type distance measurement apparatus configured to measure the distance from a target object based on the reflection of light, the distance measurement is performed by measuring the amount of light returning from the target object. Therefore, if the target object is made of a material that absorbs a great quantity of light or a material excellent in reflectance, the accuracy in measuring the distance deteriorates greatly. In particular, an object having a black or dark surface tends to absorb a great quantity of light. Further, in a case where an object surface has fine granularity and reflects most of light, the object surface tends to be detected as a speculum component, i.e., a white area having the maximum luminance, in the captured image.

### SUMMARY OF THE INVENTION

The present invention is directed to a technique capable of reducing an error in the distance measurement value that may occur when a measurement target object or the apparatus itself moves.

According to an aspect of the present invention, an image processing apparatus includes a distance measuring unit configured to measure a distance from a target object and generate first distance data, an image acquisition unit configured to acquire a captured image including the target object, a reliability calculating unit configured to calculate a reliability level with respect to a measurement value of the first distance data based on at least one of the captured image and the first distance data, and a distance data generating unit configured to extract a highly reliable area from the measurement value of the first distance data based on the calculated reliability and generate second distance data that is more reliable compared to the first distance data.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a functional configuration of an MR presentation system according to an exemplary embodiment.

FIG. 2 is a block diagram illustrating an example configuration of the MR presentation system according to a first exemplary embodiment.

FIG. 3 is a flowchart illustrating an example procedure of processing that can be performed by the MR presentation system according to the first exemplary embodiment.

FIG. 4 schematically illustrates a usage environment in which the MR presentation system is operable.

FIG. 5 schematically illustrates an example of hands displayed in an MR space.

FIG. 6 schematically illustrates another example of hands displayed in the MR space.

FIG. 7 schematically illustrates another example of hands displayed in the MR space.

FIG. 8 schematically illustrates a problem that may occur when a TOF-type distance measurement is performed in the MR system.

FIG. 9 schematically illustrates an example of a captured image.

FIG. 10 schematically illustrates an example of a polygon mesh representing a left hand.

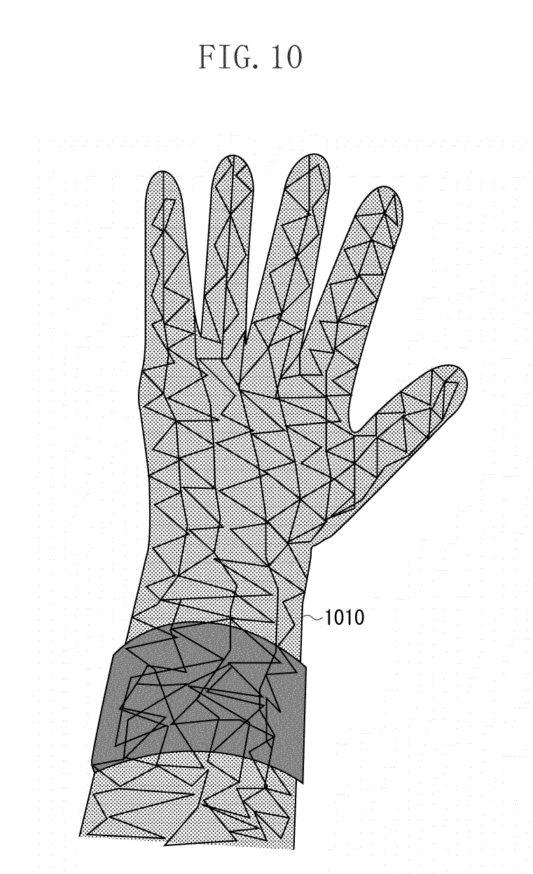

FIG. 11 schematically illustrates an example of a polygon mesh that includes a large measurement error in a state where the left hand is moving.

FIG. 12 illustrates a cross section of a left hand.

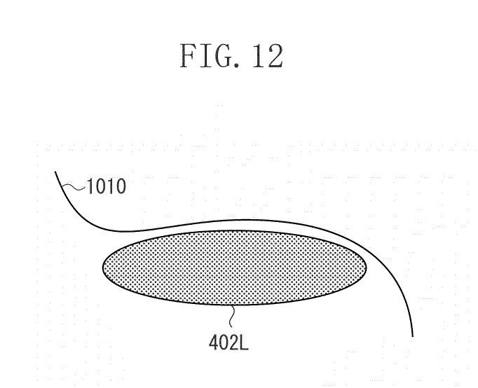

FIG. 13 illustrates an example of a reliability image according to an exemplary embodiment.

FIG. 14 schematically illustrates a flow of distance measurement value correction processing according to the first exemplary embodiment.

FIG. 15 is a flowchart illustrating an example procedure of processing that can be performed by an MR presentation system according to a second exemplary embodiment

FIG. 16 is a flowchart illustrating an example procedure of processing that can be performed by an MR presentation system according to a third exemplary embodiment.

FIG. 17 schematically illustrates an example of a polygon mesh in a highly reliable area according to the third exemplary embodiment.

### DESCRIPTION OF THE EMBODIMENTS

Various exemplary embodiments, features, and aspects of the invention will be described in detail below with reference to the drawings.

In the following description, an image processing apparatus according to a preferred embodiment of the present invention is incorporated in a mixed reality (MR) presentation system using a video see-through type head-mounted display (HMD).

The MR presentation system is configured to present a composite image, which can be obtained by combining a real space image with a virtual space image (e.g., a computer graphics image), to a user (i.e., an MR experiencing person). Presenting such a composite image enables a user to feel as if a virtual object that does not exist in the real space, such as a computer aided design (CAD) model, were actually present there. The MR technique is, for example, discussed in detail in H. Tamura, H. Yamamoto and A. Katayama: “Mixed reality: Future dreams seen at the border between real and virtual worlds,” Computer Graphics and Applications, vol.21, no.6, pp.64-70, 2001.

To express the MR space, it is essentially required to estimate the relative position and orientation between a standard coordinate system defined in the real space (i.e., a coordinate system in the real space to be referred to in determining the position and orientation of a virtual object to be superimposed in a real space) and a camera coordinate system. This is because camera parameters to be used in rendering the virtual object at a designated position in the real space are required to be identical to actual camera parameters defined in the standard coordinate system.

In the present exemplary embodiment, the camera parameters include internal camera parameters (e.g., focal length and principal point) and external camera parameters representing the camera position and orientation. The camera used in the present exemplary embodiment has a constant focal length. Therefore, internal camera parameters are fixed values that can be prepared beforehand.

For example, in a case where the display of a virtual object is superimposed on the image of an actual table at a specific position, it is useful to define the standard coordinate system on the table and obtain the position and orientation of the camera in the standard coordinate system. In the following description, the relative position and orientation between the standard coordinate system and the camera is expediently referred to as “camera position and orientation.” The relative position and orientation between the standard coordinate system and the camera is uniquely transformable information that represents essentially the same phenomenon.

More specifically, the camera position and orientation is, for example, the position and orientation of the camera defined in the standard coordinate system, the position and orientation of the standard coordinate system relative to the camera, or a data format that can express the above-mentioned information (e.g., a coordinate transformation matrix usable in transformation from the standard coordinate system to the camera coordinate system, or a coordinate transformation matrix usable in transformation from the camera coordinate system to the standard coordinate system).

When a user experiences the MR with a video see-through type HMD, it is general to superimpose a virtual object on a captured image obtained by the camera in such a way as to display the virtual object with a background.

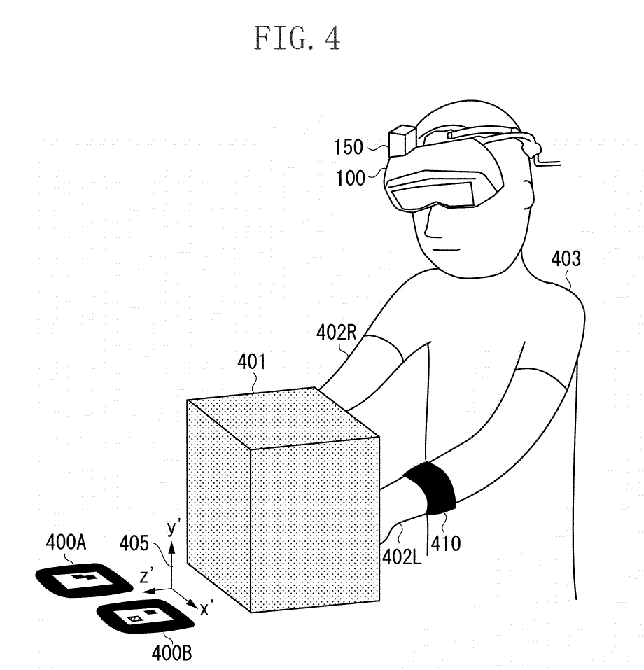

In the following description, an MR experiencing person 403 wears an HMD 100 on the head as illustrated in FIG. 4 and HMD 100 displays a virtual object 401 (i.e., a three-dimensional model having a rectangular parallelepiped body) as if the virtual object 401 were present in the real space, as described below in detail below. In the state illustrated in FIG. 4, it is presumed that the left hand 402L and a right hand 402R of the MR experiencing person 403 are in contact with the virtual object 401.

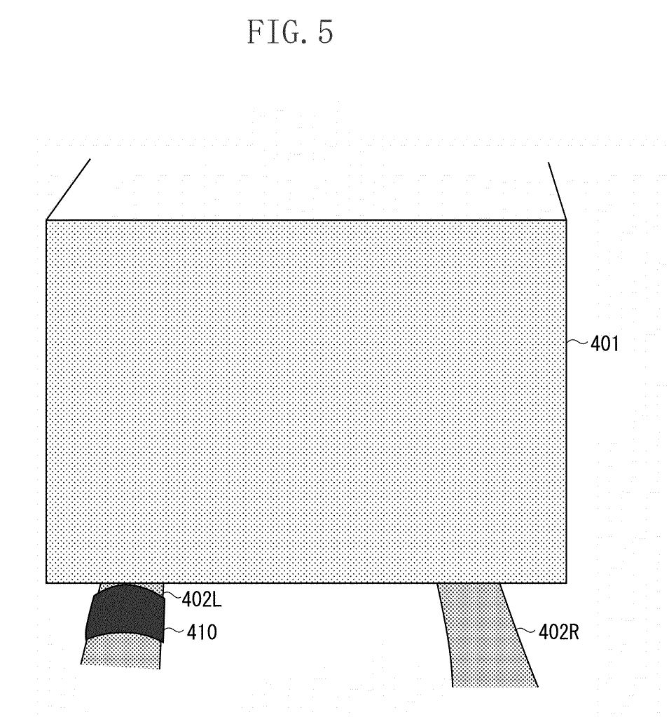

Further, FIG. 5 schematically illustrates an image presented by a display device incorporated in the HMD 100, which can be seen from the MR experiencing person 403. In the captured image illustrated in FIG. 5, the virtual object 401 is displayed in front of the hands 402L and 402R. In a case where the MR experiencing person 403 is sure about depth perception in the relationship between the virtual object 401 and the hands 402L and 402R, the MR experiencing person 403 will be subjected to visual uncomfortable feeling if the presented video is inconsistent with its own depth perception as illustrated in FIG. 5.

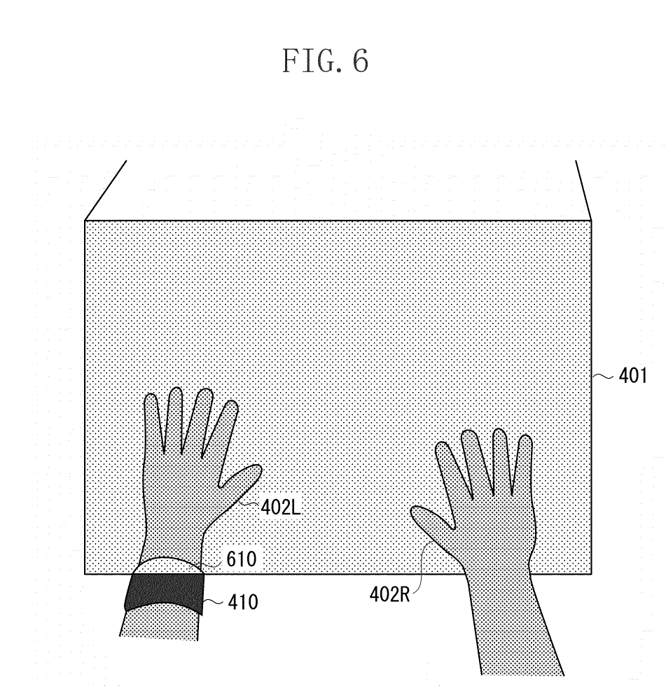

To suppress the visual uncomfortable feeling, it is feasible to extract a flesh color area from the image and display the image without overwriting the image of the virtual object 401 on the flesh color area, for example, as discussed in Japanese Patent Application Laid-Open No. 2003-296759. FIG. 6 schematically illustrates an example image of the virtual object 401 that is not rendered in the flesh color area.

However, a wrist band 410 is present in the displayed region of the hand 402L as illustrated in FIG. 6. In such a situation, if the color of the wrist band 410 is not the flesh color, the image of the virtual object 401 is erroneously rendered in a partial area 610. To solve the above-mentioned problem, a technique discussed in Kenichi Hayashi, Hirokazu Kato, and Shogo Nishida: “Depth Determination of Real Objects and Virtual Objects using Contour Based Stereo Matching”, Journal of the Virtual Reality Society of Japan, vol.10, no.3, pp.371-380, 2005.9, includes measuring the distance from a contour line of an area obtained based on an image difference between a captured image and the background, according to a stereo method, and performing depth determination (i.e., comparison by Z buffer) to realize rendering in such a way as to consider the depth.

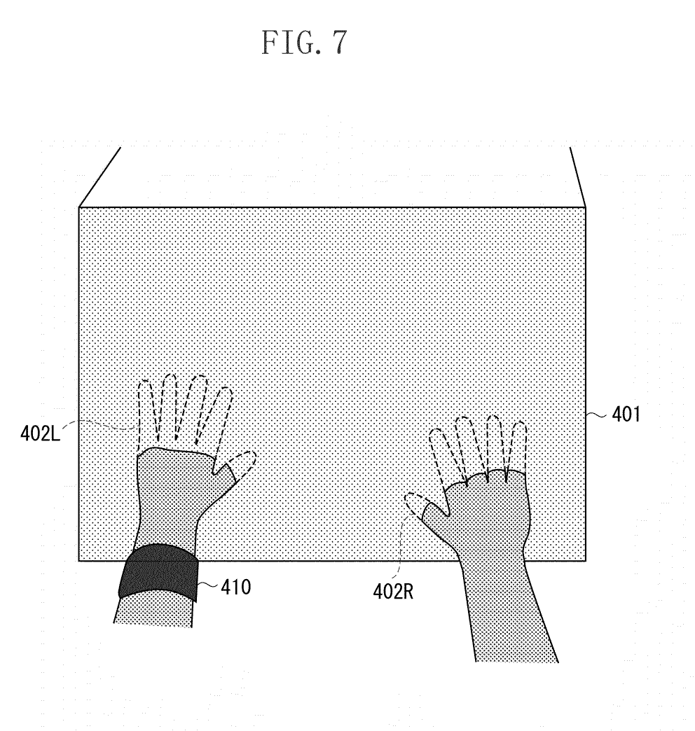

According to the above-mentioned method, an area in which no image of the virtual object 401 is displayed is determined based on the image difference between the captured image and the background, not the color. Therefore, the image of the virtual object 401 is not displayed in the region corresponding to the wrist band 410. The visual uncomfortable feeling of the experiencing person can be suppressed. Further, according to the above-mentioned method, it is feasible to estimate a contact area where the hand is brought into contact with the virtual object 401 by obtaining the distance from the camera to the contour line. Therefore, a video with visually less sense of incongruity can be generated as illustrated in FIG. 7.

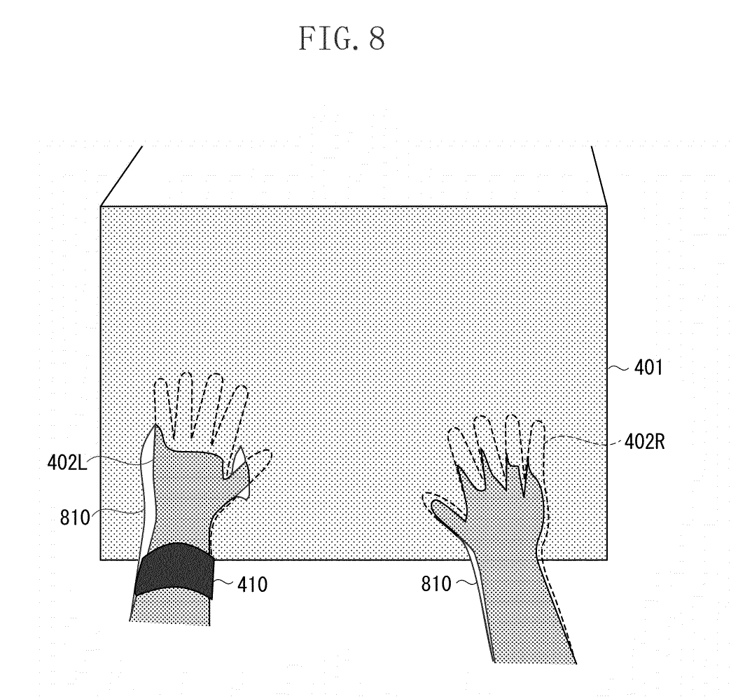

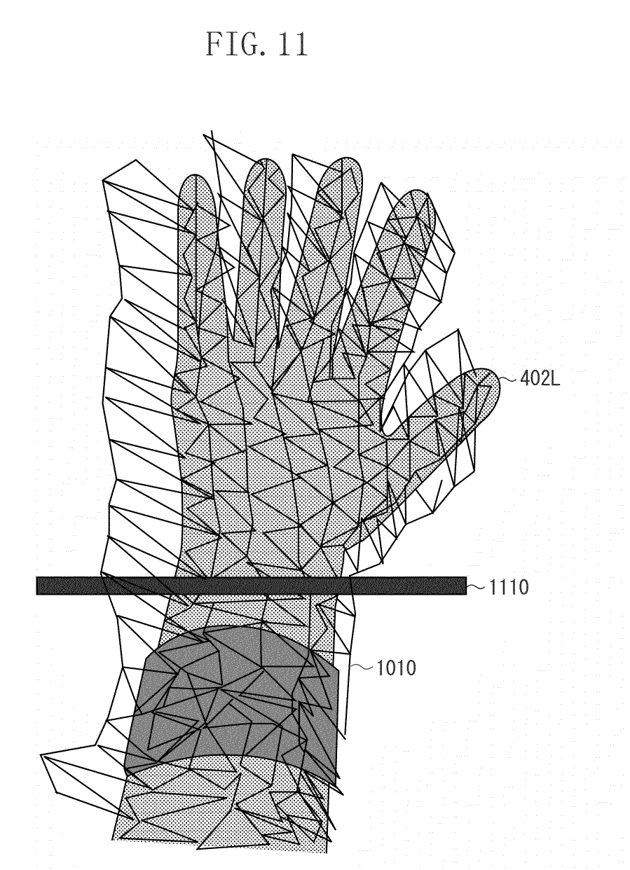

However, as mentioned above, the measurement accuracy of a conventional TOF-type distance measurement apparatus may deteriorate depending on a variation in the relative position between a target object and the apparatus. In particular, in a case where a distance measuring unit 150 is attached to the head as illustrated in FIG. 4, the deviation in relative position from the target object in a measurement direction tends to become greater. If a large error is caused in the relationship between the three-dimensional polygon mesh 1010 obtained from a distance measurement result and the left hand 402L as illustrated in FIG. 11, it is unfeasible to obtain the video illustrated in FIG. 7. The generated video of the virtual object 401 may include a defective part 810 as illustrated FIG. 8.

The system according to the present exemplary embodiment intends to reduce an error in the distance measurement value that may occur when the relative position between the distance measuring unit 150 and a measurement target dynamically changes as illustrated in FIG. 4. To this end, the present exemplary embodiment provides an MR presentation system that can prevent the feeling of immersion from being worsened due to a distance measurement error as illustrated in FIG. 8 is described in detail below.

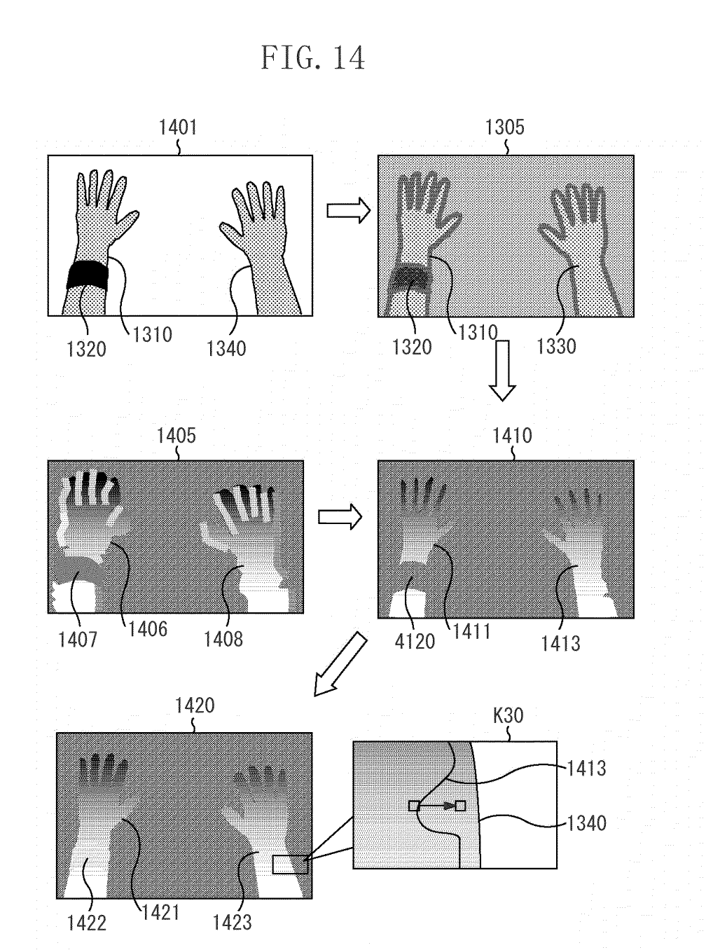

FIG. 14 schematically illustrates images that can be generated through distance measurement value correction processing according to the present exemplary embodiment. The correction processing is schematically described below. First, in the present exemplary embodiment, the MR presentation system generates a reliability image 1305 indicating a reliability level of the distance measurement value at respective pixels of a captured image 1401 when a camera 101 acquires the image 1401.

Next, the MR presentation system generates a high reliability distance image 1410 by mapping distance measurement values of a distance image 1405 (i.e., an image expressing distance data) on the reliability image 1305. However, in this case, the MR presentation system maps the distance measurement values while excluding errors that may occur when a target object is moving, in such a way as to perform the mapping with reference to the reliability of a corresponding pixel instead of simply performing the mapping. In the present exemplary embodiment, the distance image 1405 is an image obtained by the distance measuring unit 150 to express the distance measurement values as first distance data.

Further, the MR presentation system generates a finally corrected distance image 1420 by interpolating and extrapolating a partial area of the high reliability distance image 1410, if the area is defective compared to the original target object area included in the captured image 1401, within the region ranging to the contour line extracted from the captured image 1401. Through the above-mentioned processing flow, the MR presentation system corrects a distance measurement error of a moving target object using the captured image 1401 and the distance image 1405. An example method for generating the reliability image 1305, the high reliability distance image 1410, and the corrected distance image 1420 is described in detail below.

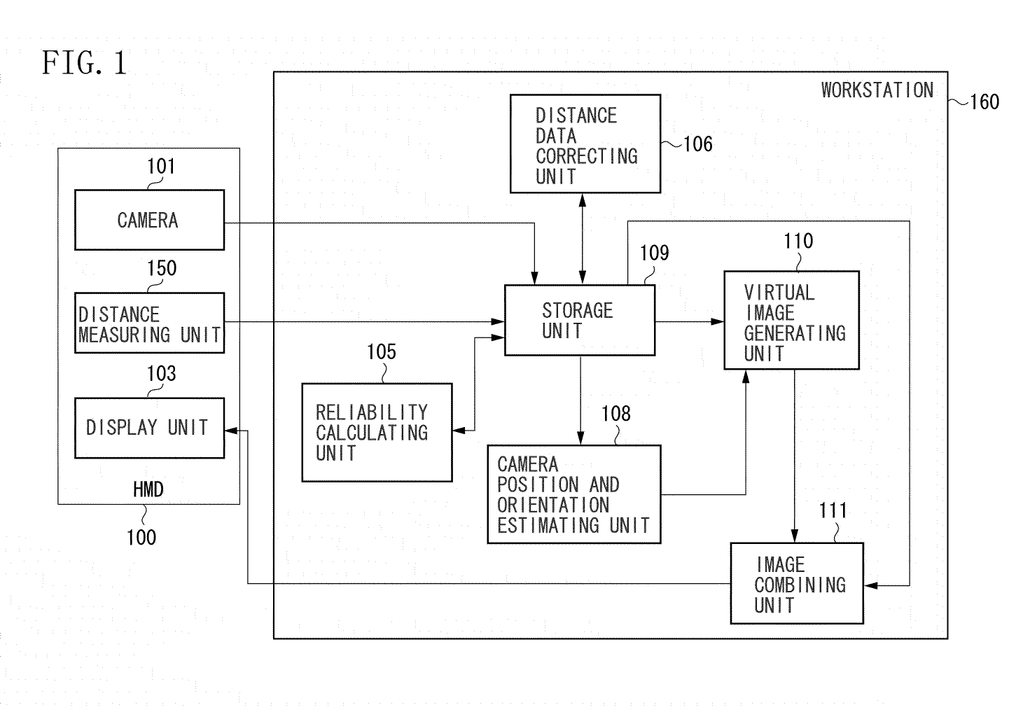

FIG. 1 is a block diagram illustrating a functional configuration of the MR presentation system incorporating the image processing apparatus according to the present exemplary embodiment. In the present exemplary embodiment, the MR presentation system enables the MR experiencing person 403 to feel as if the virtual object 401 were present in the real space. To emphasize the presence of the virtual object 401, it is desired that the depth perception of the MR experiencing person 403 is consistent with the presented video in the relationship between the virtual object 401 and the hands 402L and 402R of the MR experiencing person 403, as illustrated in FIG. 7.

In FIG. 1, the HMD 100 includes the camera 101, a display unit 103, and the distance measuring unit 150, which are fixed to the body of the HMD 100. The distance measuring unit 150 is a TOF type that is configured to emit a light beam toward a target object and measure the amount of time required for the light beam to return from the object to measure the distance between the target object and the apparatus.

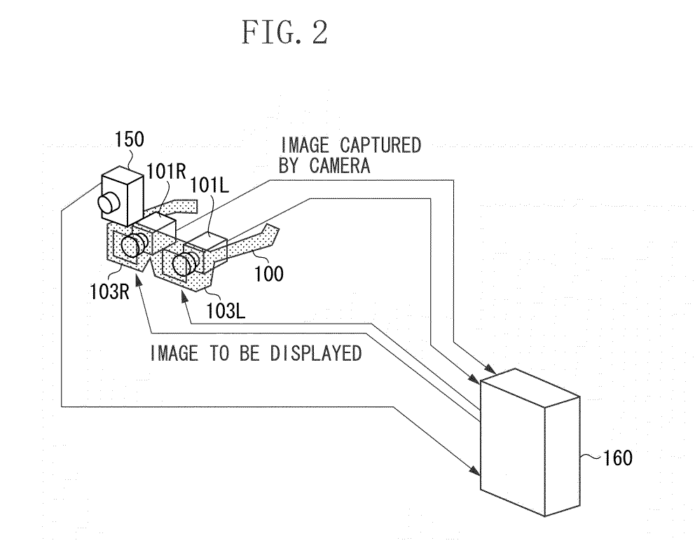

In the present exemplary embodiment, as illustrated in FIG. 2, the HMD 100 includes a pair of the camera 101 and the display unit 103, which is provided in the body thereof, for each of the right eye and the left eye. More specifically, a camera 101R and a display unit 103R are united as a set for the right eye. A camera 101L and a display unit 103L are united as another set for the left eye. Thus, the MR presentation system can present an independent image to each of the right eye and the left eye of the MR experiencing person 403 who wears the HMD 100 on the head. In other words, the MR presentation system can realize the display of stereo images.

In the present exemplary embodiment, the MR presentation system combines a real space image captured by the camera 101R with a virtual space image for the right eye generated by a workstation 160 to obtain a superimposed image (hereinafter, referred to as “MR image”) and displays the obtained MR image on the display unit 103R for the right eye. Further, the MR presentation system combines a real space image captured by the camera 101L with a virtual space image for the left eye generated by the workstation 160 to obtain a superimposed image (i.e., an MR image) and displays the obtained MR image on the display unit 103L for the left eye. As a result, the MR experiencing person 403 can observe stereoscopic MR images.

The processing described below is not essentially limited to presenting stereoscopic MR images for the MR experiencing person 403. More specifically, the processing according to the present exemplary embodiment is applicable to a case where one set of a camera and a display unit is commonly provided for the right and left eyes, or provided for a single eye, to enable a user to observe a monaural image.

Further, in the present exemplary embodiment, the HMD 100 is a unit configured to present an MR image to the MR experiencing person 403. However, the processing described below is not essentially limited to the above-mentioned apparatus, and can be applied to any apparatus that includes at least one pair of the camera 101 and the display unit 103. Further, it is unnecessary that the camera 101 and the display unit 103 are mutually fixed. However, it is necessary that the camera 101 and the distance measuring unit 150 are fixed adjacently in such a way as to measure the same environment.

The workstation 160 illustrated in FIG. 1 is described in detail below. A storage unit 109 stores images captured by the camera 101 and the above-mentioned distance images generated by the distance measuring unit 150. Further, the storage unit 109 stores information necessary when the MR presentation system performs processing according to the present exemplary embodiment. The information stored in the storage unit 109 can be read or updated according to the processing.

For example, the information necessary for the processing to be performed by the MR presentation system includes a presently captured image, a previously captured image of the preceding frame, a distance image, information about the position and orientation of the camera 101, and history information about the position and orientation of the distance measuring unit 150. Further, the information necessary for the processing to be performed by the MR presentation system includes a homography transformation matrix corrected beforehand for captured image and distance image, internal camera parameters (e.g., focal length, principal point position, and lens distortion correction parameter), marker definition information, and captured image contour information.

Further, the information necessary for the processing to be performed by the MR presentation system includes information about the speed of the distance measuring unit 150, information about the moving direction of the distance measuring unit 150, information about the above-mentioned reliability image, high reliability distance image, and corrected distance image, and model information of the virtual object 401. The present exemplary embodiment is not limited to using the above-mentioned items. The number of items to be used can be increased or reduced according to the processing content.

Further, the storage unit 109 includes a storage area capable of storing a plurality of captured images, so that the captured images can be stored as frames of a moving image.

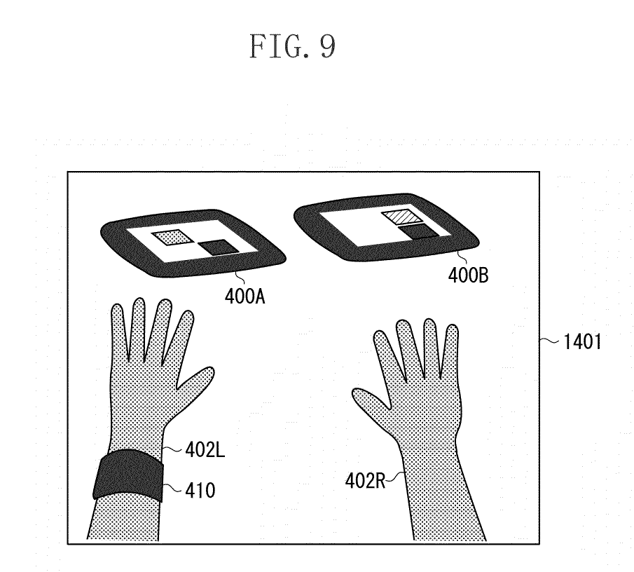

A camera position and orientation estimating unit 108 is configured to obtain position and orientation information about the camera 101 and the distance measuring unit 150 based on the captured images stored in the storage unit 109. In the present exemplary embodiment, for example, as illustrated in FIG. 9, the camera position and orientation estimating unit 108 detects two rectangular markers 400A and 400B from the captured image 1401 obtained by the camera 101 and obtains information about the position and orientation of the camera 101 with reference to coordinate values of four vertices that constitute each rectangular marker.

For example, obtaining the relative position and orientation of the camera 101 based on the coordinate values of the rectangular markers 400A and 400B can be realized by using the camera position and orientation estimation method discussed in Hirokazu Kato, Mark Billinghurst, Ivan Poupyrev, Kenji Imamoto, and Keihachiro Tachibana, “Virtual Object Manipulation on a Table-Top AR Environment”, Proc. of IEEE and ACM International Symposium on Augmented Reality 2000, pp.111-119 (2000).

More specifically, the above-mentioned camera position and orientation estimation method includes calculating a three-dimensional orientation of the marker in the standard coordinate system using the outer product direction of neighboring normal lines of four normal lines that constitute side surfaces, of a square-pyramid that can be formed by connecting four vertices of an imaged rectangular marker area to the origin of the camera coordinate system.

Further, the camera position and orientation estimation method includes performing geometric calculation to obtain information about three-dimension position from the three-dimensional orientation, and storing the obtained information about the position and orientation of the camera 101 as a matrix.

The method for obtaining the information about the position and orientation of the camera is not limited to the usage of the above-mentioned rectangular marker. As another employable method, it is useful to use a magnetic sensor or an optical sensor to measure the position and orientation of a moving head.

Next, the camera position and orientation estimating unit 108 obtains information about the position and orientation of the distance measuring unit 150 by multiplying the stored matrix with a matrix representing the relative position and orientation between the camera 101 and the distance measuring unit 150 measured beforehand and stored in the storage unit 109. Then, the obtained information about the position and orientation of the camera 101 and the information about the position and orientation of the distance measuring unit 150 are stored in the storage unit 109.

However, in this case, the information about the position and orientation of the distance measuring unit 150 is stored together with time information about recording of the position and orientation, as history information about the position and orientation of the distance measuring unit 150.

Further, when the above-mentioned information has been stored in the storage unit 109, the camera position and orientation estimating unit 108 can calculate the moving speed and the moving direction based on a difference between the preceding position and orientation of the distance measuring unit 150 and the present position and orientation of the distance measuring unit 150. The calculated data is stored in the storage unit 109. As mentioned above, the camera position and orientation estimating unit 108 can detect the moving speed and the moving direction.

A reliability calculating unit 105 is configured to generate a reliability image that represents a reliability level of a distance measurement value measured by the distance measuring unit 150 based on the captured image and the history information about the position and orientation of the distance measuring unit 150 stored in the storage unit 109. The reliability level can be set as an integer value in the range between 0 and 255. When the reliability level is higher, the distance measurement value can be regarded as having higher reliability. The reliability calculating unit 105 determines the reliability level of each pixel of a captured image on a pixel-by-pixel basis and finally stores a gray scale image having a luminance value expressing the reliability level as illustrated in FIG. 14, as the reliability image, in the storage unit 109.

A distance data correcting unit 106 is configured to associate each pixel of a reliability image stored in the storage unit 109 with a distance measurement value of a distance image obtained by the distance measuring unit 150. In the above-mentioned association processing, if the resolution of the distance image is different from the resolution of the reliability image, it is useful to employ a method discussed in Qingxiong Yang, Ruigang Yang, James Davis and David Nister, “Spatial-Depth Super Resolution for Range Images”, IEEE Computer Society Conference on Computer Vision and Pattern Recognition (CVPR), 2007, Pages: 1-8, according to which a distance image to be associated with the reliability image results from super-resolution processing applied to the original distance image. More specifically, when the distance data correcting unit 106 performs super-resolution processing on the distance image, the distance data correcting unit 106 performs interpolation processing based on a difference in color or luminance value at a corresponding pixel of a captured image, instead of simply performing the interpolation processing.

The distance data correcting unit 106 is further configured to refuse or select a distance measurement value associated according to the reliability level stored in the reliability image. In the present exemplary embodiment, for example, a threshold value is set for the reliability level beforehand. The distance data correcting unit 106 extracts a distance measurement value only when its reliability level exceeds the threshold value and does not use the remaining distance measurement values.

The distance measurement values having been selected as mentioned above are stored, as a high reliability distance image corresponding to respective pixels of the captured image, in the storage unit 109. The present exemplary embodiment is not limited to the above-mentioned method for setting the threshold value to remove distance measurement values that are insufficient in the reliability level. For example, as another employable method, it is useful to generate a histogram of reliability levels from the reliability image and select distance measurement values that correspond to the top ten reliability levels, each of which has a reliability level equal to or greater than 128 and has a higher frequency in the histogram.

The high reliability distance image, which has been selected and updated based on reliability level information (see the schematic procedure illustrated in FIG. 14), does not include any distance measurement values in the removed region. Therefore, the distance data correcting unit 106 performs interpolation and extrapolation processing in such a way as to compensate each defective area within the region ranging to the contour line obtained from the captured image. Then, the distance data correcting unit 106 stores the image obtained by compensating any defective area, as a corrected distance image, in the storage unit 109.

A virtual image generating unit 110 is configured to generate (render) an image of a virtual object that can be seen from the point of view of the camera 101, based on the information about the position and orientation of the camera 101 output from the camera position and orientation estimating unit 108. However, when the virtual image generating unit 110 generates a virtual object image, the virtual image generating unit 110 compares a Z buffer value of the present rendering place with a distance measurement value at a pixel corresponding to the corrected distance image generated by the distance data correcting unit 106.

More specifically, only when the Z buffer value is greater than the distance measurement value, the virtual image generating unit 110 renders the image of the virtual object. Through the above-mentioned processing, when an image combining unit 111 combines the virtual object image with the captured image, the hands 402L and 402R (i.e., actual target objects) can be positioned in front of the virtual object 401 when the composite image is presented to an experiencing person, without being overwritten on the image of the virtual object 401, as illustrated in FIG. 7.

The image combining unit 111 is configured to generate a composite image (MR image) by combining the captured image stored in the storage unit 109 with the virtual object image (i.e., the virtual space image) generated by the virtual image generating unit 110. The image combining unit 111 can perform the above-mentioned combination processing by superimposing the virtual space image on the captured image. Then, the image combining unit 111 outputs the MR image to the display unit 103 of the HMD 100. Thus, the MR image can be displayed on the display unit 103 in such a way as to superimpose the virtual space image on the real space image according to the position and orientation of the camera 101. The obtained MR image can be presented to an MR experiencing person wearing the HMD 100 on the head.

In FIG. 1, the functional configuration of the workstation 160 includes all functions except for the hardware attached to the HMD 100. A fundamental hardware configuration of the workstation 160 includes a central processing unit (CPU), a random access memory (RAM), a read only memory (ROM), an external storage device, a storage medium drive, a keyboard, and a mouse. The CPU can control the entire workstation 160 according to a software program and data loaded from the RAM or the ROM. Further, the CPU can execute sequential processing including generating an MR image and outputting the MR image to the display unit 103 of the HMD 100.

The RAM includes a storage area that can temporarily store the software program and data read from the external storage device or the storage medium drive and a work area that can be used when the CPU executes various processing. The ROM stores a boot program and any other program for controlling the workstation 160, together with related data. The keyboard and the mouse are functionally operable as an input unit configured to input each instruction, when it is received from a user, to the CPU. A massive information storage device, which is generally represented by a hard disk drive, stores an operating system (OS) in addition to the software program and related data required when the CPU executes sequential processing including generating the above-mentioned MR image and outputting the MR image to the display unit 103. The software program and data stored in the storage device can be loaded into the RAM and can be executed by the CPU.

It is useful to install an appropriate software program on the workstation 160 if the installed program can realize the functions of the reliability calculating unit 105, the distance data correcting unit 106, the camera position and orientation estimating unit 108, the virtual image generating unit 110, and the image combining unit 111 illustrated in FIG. 1. In this case, the above-mentioned software program is stored in the external storage device and can be occasionally loaded into the RAM to enable the CPU to perform processing based on the program. As mentioned above, the workstation 160 can execute sequential processing including generating an MR image and outputting the MR image to the display unit 103.

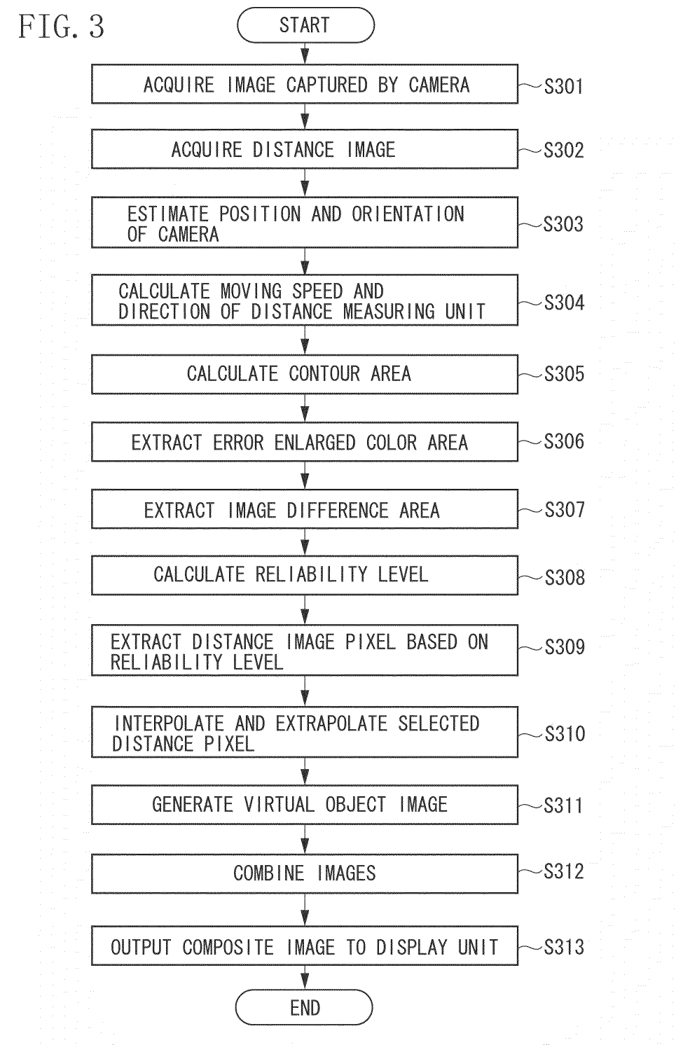

Next, example processing that can be performed by the MR presentation system according to the present exemplary embodiment is described in detail below with reference to a flowchart illustrated in FIG. 3. The MR presentation system repetitively performs the processing of the flowchart illustrated in FIG. 3 every time when a piece of MR image data is rendered.

First, the MR presentation system starts processing in response to an input of a captured image from the camera 101. Then, in step S301, the storage unit 109 copies a presently stored captured image to another storage area that is allocated to a previously captured image of the preceding frame. Then, the storage unit 109 stores an image newly captured by the camera 101 in the presently captured image area of the storage unit 109.

Next, in step S302, the storage unit 109 stores a distance image generated by the distance measuring unit 150. In the present exemplary embodiment, the distance image is, for example, the distance image 1405 illustrated in FIG. 14, whose resolution is comparable to that of the captured image. For example, a 16-bit gray scale image having a value in the range from 0x0000 to 0xFFFF is usable.

Next, in step S303, the camera position and orientation estimating unit 108 detects the markers included in the captured image and estimates the position and orientation of the camera 101 and the position and orientation of the distance measuring unit 150 using the above-mentioned method. Then, in step S304, the camera position and orientation estimating unit 108 calculates the moving speed and the moving direction of the distance measuring unit 150 with reference to the history information about the position and orientation of the distance measuring unit 150 stored in the storage unit 109, and stores the calculated values in the storage unit 109.

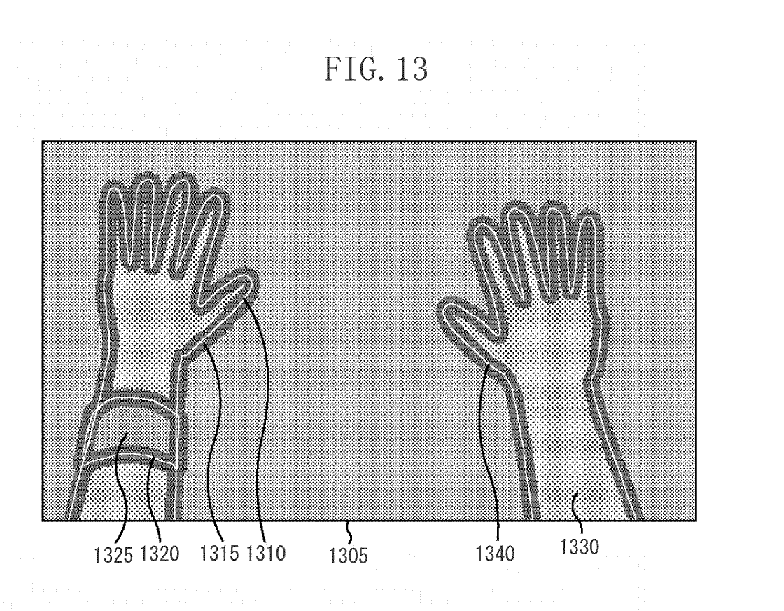

Next, in step S305, the reliability calculating unit 105 determines a contour area based on the captured image and the information about the moving speed and the moving direction of the distance measuring unit 150. The above-mentioned processing is described in detail below with reference to FIGS. 13 and 14.

First, the reliability calculating unit 105 applies, for example, the Sobel operator to the captured image 1401 illustrated in FIG. 14 and extracts contour lines 1310, 1320, and 1340 illustrated in FIG. 13. However, the method for extracting the contour lines is not limited to the usage of the Sobel operator. Any other method capable of extracting contour lines from an image is employable. Further, reducing an error in measuring the distance value when the head is moving is intended in the present exemplary embodiment. Therefore, even in a state where a blur appears in the captured image 1401, using the operator capable of accurately extracting the contours is desired.

Further, the reliability calculating unit 105 expands the extracted contour lines in proportion to the moving speed and the moving direction of the distance measuring unit 150 stored in the storage unit 109. For example, the reliability calculating unit 105 increases the expansion amount in proportion to the moving speed of the distance measuring unit 150 stored in the storage unit 109. The distance measurement value obtained by the distance measuring unit 150 is characteristic in that an error area in the contour of the target object increases if the hands 402L and 402R (i.e., the target objects) moves time-sequentially at higher speeds. Therefore, it is necessary to enlarge a reliability lowering area according to the characteristics to remove the error area. The above-mentioned processing is similarly applicable when the shape of the target object varies time-sequentially.

Further, the reliability calculating unit 105 estimates the moving direction of the target object in the captured image 1401 as a two-dimensional vector, which has an image component in the vertical direction and an image component in the horizontal direction, based on the moving direction of the distance measuring unit 150 stored in the storage unit 109. For example, the reliability calculating unit 105 sets a virtual reference point disposed in a three-dimensional space beforehand and performs perspective projective transformation to obtain a projecting point of the preceding frame by projecting a point in the three-dimension space on a projection surface, based on the previously measured position and orientation of the camera 101 and the internal camera parameters.

Next, the reliability calculating unit 105 obtains a present projecting point by projecting the three-dimension reference point perspectively on the projection surface, based on the present position and orientation of the camera 101 and the internal camera parameters. Then, the reliability calculating unit 105 can set a vector difference between the above-mentioned projecting point of the preceding frame and the present projecting point on the image, as a two-dimensional vector indicating the moving direction of the target object. Although the moving direction of the target object in the distance image 1405 should be calculated, in the present exemplary embodiment, the distance measuring unit 150 and the camera 101 are disposed in such a way as to face the same direction.

Further, the reliability calculating unit 105 sets the vertical component of the above-mentioned two-dimensional vector to be proportional to a vertical expansion rate and sets the horizontal component of the two-dimensional vector to be proportional to a horizontal expansion rate. The distance measurement values are characteristic in that the error area increases in the contour area vertical to the moving direction if the hands 402L and 402R (i.e., target objects) move at higher speeds in one direction. Therefore, it is necessary to remove the error area by lowering the reliability of the above-mentioned area. Through the above-mentioned processing, the reliability calculating unit 105 can calculate a contour area 1315 illustrated in FIG. 13 from the captured image 1401.

Next, in step S306, the reliability calculating unit 105 extracts a color area in which a designated error is enlarged (hereinafter, referred to as “error enlarged color area”) from the captured image. In a case where the reliability calculating unit 105 processes the example illustrated in FIG. 14, the reliability calculating unit 105 extracts a black area from the captured image 1401. For example, the reliability calculating unit 105 extracts an area in which the luminance of a pixel is lower than a threshold value having been set beforehand as a black area.

Then, the reliability calculating unit 105 extracts, as a speculum component, a white area (i.e., a maximum luminance area) that enlarges the error in the distance measurement value. For example, in a case where the luminance component of the captured image 1401 is expressed using an 8-bit data, the reliability calculating unit 105 extracts an area in which the luminance value is 255. As mentioned above, the reliability calculating unit 105 extracts an error enlarged color area 1325 of the wrist band contour line 1320 illustrated in FIG. 13 with respect to the black wrist band area of the captured image 1401.

Next, in step S307, the reliability calculating unit 105 extracts a difference area by obtaining a difference between the presently captured image and the previously captured image of the preceding frame stored in the storage unit 109. To obtain the difference area, for example, the reliability calculating unit 105 compares a luminance component of the previously captured image of the preceding frame with a luminance component of the presently captured image. Then, if the difference between the compared luminance components is greater than a threshold value determined beforehand, the reliability calculating unit 105 extracts the area as a target area. The above-mentioned processing is based on the fact that a measurement error occurring when the target moves at a higher speed in a state where the distance measuring unit 150 is stationary is similar to a difference area between the previously captured image of the preceding frame and the presently captured image.

Next, in step S308, the reliability calculating unit 105 generates a reliability image using the contour area calculated in step S305, the error enlarged color area calculated in step S306, and the difference area calculated in step S307. Example processing for generating the reliability image 1305 illustrated in FIG. 13 is described in detail below.

The reliability image 1305 is, for example, an 8-bit gray scale image that has a resolution comparable to that of the captured image 1401 and takes an integer value in the range from 0 to 255. However, the reliability image 1305 is not limited to the 8-bit gray scale image. First, the reliability calculating unit 105 sets the reliability level to an initial value “255” for all pixels that constitute the reliability image 1305. Next, the reliability calculating unit 105 lowers the reliability level by subtracting a specific numerical value from each pixel (i.e., reliability level) of the reliability image 1305 that corresponds to the contour area calculated in step S305.

As mentioned above, the reliability calculating unit 105 updates the reliability image 1305 by lowering the reliability level in the contour area. However, any other numerical value is usable if it serves as the parameter capable of extracting an area having a higher measurement error in the processing for extracting a distance image with reference to the reliability level, which is described below. Further, it is useful to weight the value to be subtracted in such a way as to minimize the reliability level of the contour line initially obtained in step S305 and gradually increase the reliability level in accordance with the distance from the contour area in the outward direction.

Next, the reliability calculating unit 105 further sets a lowered reliability level by subtracting a specific value from the reliability level of the reliability image 1305 that corresponds to the error enlarged color area calculated in step S306. Further, the reliability calculating unit 105 sets a lowered reliability level by subtracting a specific value from the reliability level of the reliability image 1305 that corresponds to the image difference area calculated in step S307.

If a negative reliability level is obtained through the above-mentioned subtraction processing, the reliability calculating unit 105 sets the reliability level to “0.” The reliability calculating unit 105 calculates the reliability image 1305 illustrated in FIG. 13 through the above-mentioned processing and stores the reliability image 1305 in the storage unit 109. The reliability image 1305 does not include any actual recording relating to the above-mentioned contour lines 1310, 1320, and 1340 which are described only for convenience of explanation.

Next, in step S309, the distance data correcting unit 106 generates a high reliability distance image, which is second distance data, using the reliability image and the distance image stored in the storage unit 109. The above-mentioned processing is described in detail below with reference to the examples illustrated in FIGS. 13 and 14.

For example, the high reliability distance image 1410 illustrated in FIG. 14 is a 16-bit gray scale image that has a resolution comparable to that of the captured image 1401 and takes a value in the range from 0x0000 to 0xFFFF. However, the high reliability distance image 1410 is not limited to the 16-bit gray scale image. The distance data correcting unit 106 sets an initial value 0xFFFF (i.e., a value indicating infinity) for all pixels that constitute the high reliability distance image 1410. Then, the distance data correcting unit 106 determines whether each reliability level (i.e., each pixel value) of the reliability image 1305 exceeds a reliability threshold value having been set beforehand.

Next, the distance data correcting unit 106 obtains a distance measurement value of the distance image 1405 that corresponds to the reliability image 1305 exceeding the threshold value and sets the obtained distance measurement value as a value of the high reliability distance image 1410. To obtain the above-mentioned distance measurement value of the distance image 1405 that corresponds to the reliability image 1305, the distance data correcting unit 106 uses the homography transformation matrix for conversion from the image coordinate system of the distance image 1405 to the image coordinate system of the captured image 1401. The homography transformation matrix is stored beforehand in the storage unit 109.

Both the captured image 1401 and the high reliability distance image 1410 are defined in the same image coordinate system. Therefore, the conversion from the captured image 1401 is unnecessary. Further, in a case where the resolution of the distance image 1405 is lower than resolution of the high reliability distance image 1410, the distance data correcting unit 106 can roughly interpolate the distance measurement value after mapping the distance measurement value on the high reliability distance image 1410. As mentioned above, the distance data correcting unit 106 stores the calculated reliability distance image 1410 in the storage unit 109.

Next, in step S310, the distance data correcting unit 106 performs interpolation or extrapolation processing within the region ranging up to the contour line initially obtained in step S305 in such a way as to correct the high reliability distance image obtained in step S309. According to the example illustrated in FIG. 14, the contour lines 1310, 1320, and 1340 of the hands and the wrist band 410 are different from contours 1411, 1412, and 1413 of the high reliability distance image 1410. Therefore, in step 5310, the distance data correcting unit 106 expands the contour of the high reliability distance image 1410 in such a way as to include the contour lines 1310, 1320, and 1340.

First, the distance data correcting unit 106 copies and extrapolates the distance measurement value in the horizontal direction toward the contour line of the captured image 1401, on the contour line of the high reliability distance image 1410. For example, in an enlarged drawing K30 in FIG. 14, the distance data correcting unit 106 copies a distance measurement value on the contour line 1413 of the high reliability distance image 1410 horizontally to the right direction until the copy reaches the contour line 1340 of the captured image 1401.

The reason why the distance data correcting unit 106 copies the distance measurement value in the horizontal direction is that it is assumed that the distance images measured by the distance measuring unit 150 are not so different from each other in the horizontal direction. The processing to be performed by the distance data correcting unit 106 in this case is not limited to the above-mentioned processing for copying the same value in the horizontal direction. For example, the distance data correcting unit 106 can obtain a mean derivative of distance measurement values at five pixels positioned on the inner side (i.e., the left side) of the contour line 1413 and can determine distance measurement values in such a way as to obtain the same derivative in the region ranging from the contour line 1413 to the contour line 1340.

Next, the distance data correcting unit 106 expands the high reliability distance image 1410 in the vertical direction. Similar to the processing in the horizontal direction, the distance data correcting unit 106 copies the distance measurement value in the vertical direction. Further, the distance data correcting unit 106 determines whether the inside areas of the contour lines 1310, 1320, and 1340 have been corrected. According to the example illustrated in FIG. 14, through the above-mentioned processing, it can be detected that an inside area 1412 of the wrist band 410 (i.e., a closed area surrounded by the contour line and having an internal distance measurement value being set to 0xFFFF) is not yet corrected.

If an uncorrected area is found in the above-mentioned determination, the distance data correcting unit 106 interpolates the distance measurement value of the contour line included in the captured image 1401 in the vertical direction. More specifically, the distance data correcting unit 106 interpolates the distance measurement value on the inner side of the contour line 1320 of the wrist band 410 in the vertical direction.

As mentioned above, the distance data correcting unit 106 calculates the corrected distance image 1420 (i.e., third distance data) by interpolating and extrapolating the high reliability distance image 1410 within the region ranging to the contour line of a target object in the captured image 1401, and stores the corrected distance image 1420 in the storage unit 109. The processed to be performed by the distance data correcting unit 106 in this case is not limited to calculating the corrected distance image 1420 through the above-mentioned interpolation and extrapolation processing. Any other method capable of accurately correcting the target object including the contour thereof, for example, by shading off the high reliability distance image 1410, is employable.

Next, in step S311, the virtual image generating unit 110 generates a virtual object image using three-dimensional model information of the virtual object and the corrected distance image stored in the storage unit 109. According to the example using the corrected distance image 1420 illustrated in FIG. 14, first, the virtual image generating unit 110 renders the three-dimensional model information of the virtual object and generates color information about the virtual object image together with the Z buffer value. In the present exemplary embodiment, it is presumed that the virtual object image is rendered in such a way as to have a resolution comparable to that of the captured image 1401. However, the resolution of the captured image is not necessarily equal to the resolution of the virtual object image. It is useful to apply scaling transformation to the captured image according to the resolution of the virtual object image.

Next, the virtual image generating unit 110 converts the Z buffer value of the virtual object image into 16-bit data and compares the distance measurement value of the corrected distance image 1420 with the corresponding Z buffer value of the virtual object image. If the distance measurement value is smaller than the compared Z buffer value, it can be presumed that the target object is positioned in front of the virtual object. Therefore, the virtual image generating unit 110 sets the transparency of color information to 1 for the virtual object image.

On the other hand, if the distance measurement value is larger than the Z buffer, it can be presumed that the target object is positioned in the rear of the virtual object. Therefore, the virtual image generating unit 110 does not change the transparency of color information for the virtual object image. The virtual image generating unit 110 outputs the virtual object image including the transparency obtained as mentioned above to the image combining unit 111.

Next, in step S312, the image combining unit 111 combines the captured image with the virtual object image generated in step S311. More specifically, the image combining unit 111 sets the captured image as a background and overwrites the virtual object image on the background in the above-mentioned combination processing. In this case, the image combining unit 111 mixes the color of the virtual object image with the color of the captured image (i.e., the background) according to the transparency. Then, in step S313, the image combining unit 111 outputs the composite image generated in step S312 to the display unit 103 of the HMD 100.

As mentioned above, the MR presentation system according to the present exemplary embodiment can generate a video to be presented as illustrated in FIG. 7, which includes an actual object and a virtual object that naturally interfere with each other, through the above-mentioned processing. The video to be presented to the MR experiencing person 403 who wears the HMD 100 in this case is close to the person's depth perception. Therefore, the MR presentation system according to the present exemplary embodiment can prevent the person's feeling of immersion from being worsened.

According to the above-mentioned first exemplary embodiment, the MR presentation system determines a reliability level based on the captured image 1401 and the information about the moving speed and the moving direction of the distance measuring unit 150. Hereinafter, as a second exemplary embodiment, a method for obtaining a reliability level of a distance measurement value using measurement history of the distance data obtained from the distance measuring unit 150 is described in detail below. An MR presentation system incorporating an image processing apparatus according to the present exemplary embodiment has a basic configuration similar to that illustrated in FIG. 1 described in the first exemplary embodiment. However, the reliability calculating unit 105 according to the present exemplary embodiment is configured to calculate a reliability level based on information about the distance image 1405, without using the captured image.

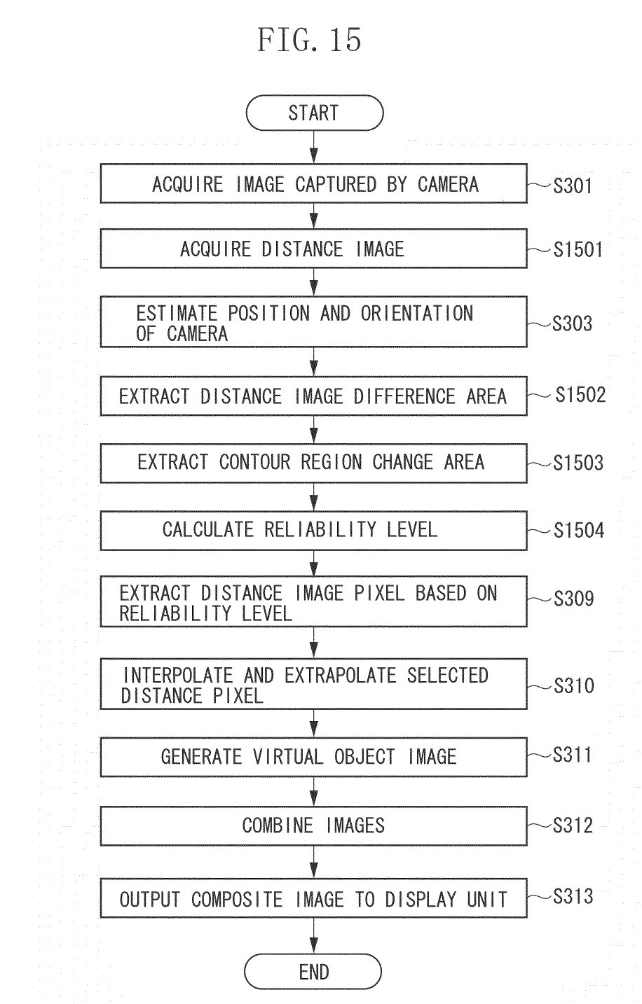

FIG. 15 is a flowchart illustrating an example procedure of processing that can be performed by the MR presentation system incorporating the image processing apparatus according to the present exemplary embodiment. In FIG. 15, the step number allocated to each processing is equal to that described in the first exemplary embodiment (see FIG. 3), if the processing content is not different. Therefore, processing to which a new step number is allocated is described in detail below.

If the MR presentation system completes the processing in step S301, then in step S1501, the distance measuring unit 150 stores the distance image presently stored in the storage unit 109 as a history of the distance image and stores a new distance image obtained from the distance measuring unit 150 in the storage unit 109.

In step S1502, the reliability calculating unit 105 compares the present distance image stored in the storage unit 109 with the previous distance image of the preceding frame and calculates a difference area. The above-mentioned processing is based on the characteristics that errors in the distance measurement result tend to occur in the difference area of the distance image. Therefore, the MR presentation system according to the present invention intends to lower the reliability level of the difference area to reduce the influence of errors.

Next, in step S1503, the reliability calculating unit 105 calculates a contour area of the distance image and performs the following processing for each pixel in the contour area (hereinafter, referred to as “contour pixel”). First, the reliability calculating unit 105 associates a contour pixel of the present frame with the closest contour pixel in the contour area of the one-frame preceding distance image. Further, the reliability calculating unit 105 compares a one-frame preceding contour pixel with a two-frame preceding contour area and sets a pixel closest to the one-frame preceding contour pixel as a corresponding contour pixel. Similarly, the reliability calculating unit 105 repeats the above-mentioned association processing until a five-frame preceding contour pixel. The reliability calculating unit 105 performs the above-mentioned processing for all pixels in the contour area of the present frame.

Next, the reliability calculating unit 105 obtains a difference value (i.e., a derivative) of distance measurement values of the above-mentioned five preceding frames associated for each pixel in each contour area. Then, if the absolute value of the difference value in each frame exceeds a threshold value and a dispersion of the difference value is within a threshold value, the reliability calculating unit 105 stores the target pixel area as a contour region change area.

The above-mentioned processing intends to identify a distance measurement error based on the characteristics that an error in the distance measurement value at a contour line in the distance image linearly increases or decreases when the target object is moving. More specifically, if the history of the distance measurement value at the contour pixel of the target object increases or decreases linearly, the reliability calculating unit 105 identifies the occurrence of a large error and lowers the reliability level to reduce the influence of the error.

Next, in step S1504, the reliability calculating unit 105 reduces the reliability levels of areas of the reliability image that correspond to the difference area of the distance image obtained in step S1502 and the contour region change area calculated in step S1503.

As mentioned above, the MR presentation system according to the present exemplary embodiment calculates a reliability level based on history information of the distance measurement value in the distance image, without using the captured image, and removes or corrects a less reliable area. Thus, when the MR presentation system presents a video to the MR experiencing person 403, the presented video is close to the person's depth perception.

In the first exemplary embodiment, the distance measuring unit 150 has been described as having the configuration to calculate a distance image and generate a high reliability distance image based on the distance image and the reliability image. Hereinafter, a third exemplary embodiment is described in detail, in which the distance measuring unit 150 is configured to generate a high reliability distance image based on a polygon mesh converted from a distance image (not the distance image itself) and a reliability image. In the present exemplary embodiment, the polygon mesh is data obtainable by disposing each distance measurement value obtained from the distance image as a point in a three-dimensional space and reconstructing a polygon that can be rendered as a virtual object by connecting respective points.

An MR presentation system incorporating an image processing apparatus according to the present exemplary embodiment has a basic configuration similar to that described in the first exemplary embodiment. However, in the present exemplary embodiment, the storage unit 109 is configured to store polygon mesh information instead of the distance image 1405. The distance data correcting unit 106 is configured to input a polygon mesh and correct the polygon mesh data. Further, the virtual image generating unit 110 is configured to render a virtual object based on the polygon mesh.

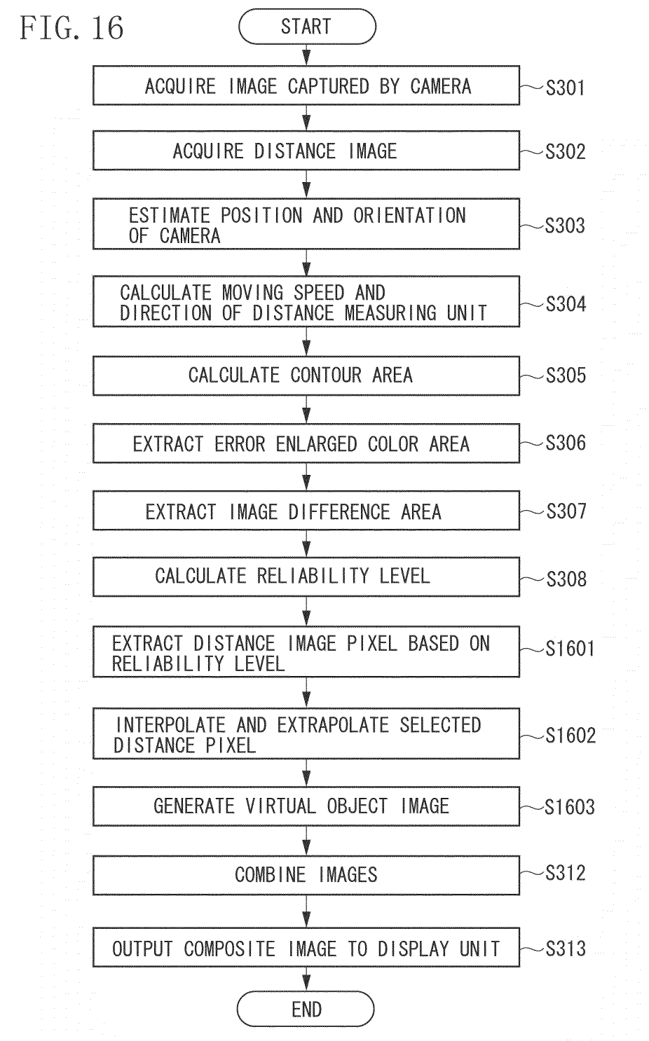

FIG. 16 is a flowchart illustrating an example procedure of processing that can be performed by an MR presentation system incorporating an image processing apparatus according to the present exemplary embodiment. In FIG. 16, the step number allocated to each processing is equal to that described in first exemplary embodiment (see FIG. 3), if the processing content is not different. Therefore, processing to which a new step number is allocated is described in detail below.

In step S1601, the distance data correcting unit 106 projects three-dimensional vertices of polygon mesh information on a projection surface of the captured image, using the internal camera parameters stored in the storage unit 109. Then, the distance data correcting unit 106 associates the vertices of the polygon mesh with the reliability image.

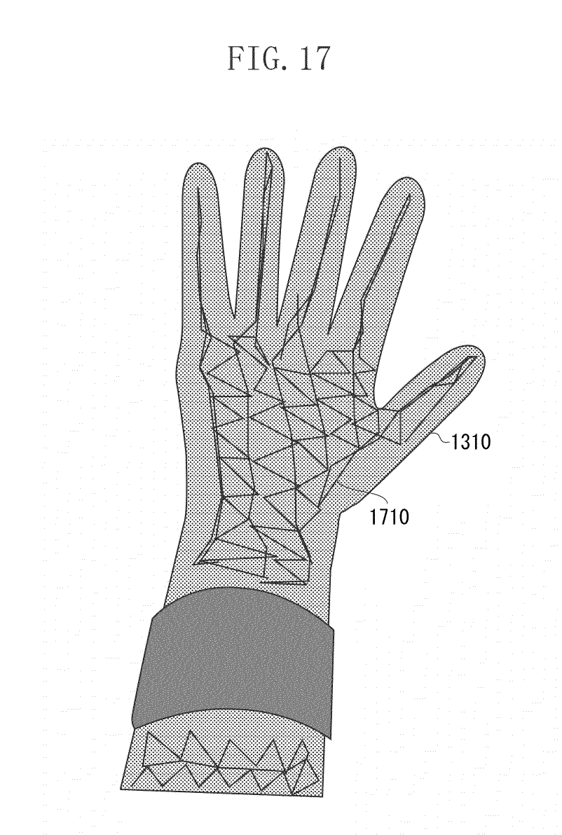

Next, the distance data correcting unit 106 deletes each vertex of the polygon mesh that corresponds to an area in which the reliability level of the reliability image is less than a threshold value designated beforehand. For example, in a case where the three-dimensional polygon mesh 1010 includes errors as illustrated in FIG. 11, the distance data correcting unit 106 obtains a polygon mesh 1710 illustrated in FIG. 17 by deleting less reliable vertices.

Next, in step S1602, the distance data correcting unit 106 selects one vertex, which constitutes a part of the contour of the polygon mesh, from the remaining vertices obtained through the processing in step S1601. Then, the distance data correcting unit 106 generates a closest point on the contour line of the captured image and copies a distance measurement value of the generated point as a distance measurement value of the vertex. Further, the distance data correcting unit 106 updates the polygon mesh by connecting a newly generated vertex to a neighboring vertex. Similarly, for all vertices constituting the contour of the mesh, the distance data correcting unit 106 generates a new mesh vertex on the contour line of the captured image and connects the generated vertex to a neighboring vertex.

Further, the distance data correcting unit 106 checks if a vertex of the polygon mesh is positioned on the contour line of the captured image. If there is not any vertex, the distance data correcting unit 106 buries a defective hole by connecting vertices of the polygon mesh positioned on the contour line. For example, there is not any vertex of the polygon mesh in the error enlarged color area 1325 of the wrist band. Therefore, the distance data correcting unit 106 buries a defective hole by connecting vertices of the polygon mesh positioned on the contour line 1320 of the wrist band. When the polygon mesh that coincides with the contour area of the captured image is obtained as mentioned above, the distance data correcting unit 106 stores the polygon mesh in the storage unit 109.

Next, in step S1603, the virtual image generating unit 110 generates a virtual object image based on the virtual object model information stored in the storage unit 109, the updated polygon mesh information, and the position and orientation of the camera 101. In this case, the virtual image generating unit 110 renders the virtual object image as a transparent object in a state where the transparency is set to 1 with respect to a rendering display attribute of the polygon mesh information. In the above-mentioned processing, the Z buffer comparison processing includes comparing the polygon mesh information with the virtual object model information in the depth direction and presenting the image of the real object to the MR experiencing person 403 in such a way as to be positioned in front of the virtual object without being overwritten on the virtual object image.

As mentioned above, even when the output of the distance measuring unit 150 is processed as a polygon mesh (not a distance image), the MR presentation system of the present exemplary embodiment can present a video that is close to the depth perception of the MR experiencing person 403. According to the above-mentioned exemplary embodiments, it is feasible to reduce errors in the distance measurement value when a measurement target object or the apparatus itself moves.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-256463 filed Nov. 22, 2012, which is hereby incorporated by reference herein in its entirety.

What is claimed is:

1. An image processing apparatus, comprising:
a distance measuring unit configured to measure a distance from a target object and generate first distance data;
an image acquisition unit configured to acquire a captured image including the target object;
a reliability calculating unit configured to calculate a reliability level with respect to a measurement value of the first distance data based on at least one of the captured image and the first distance data; and
distance data generating unit configured to extract a highly reliable area from the measurement value of the first distance data based on the calculated reliability and generate second distance data that is more reliable compared to the first distance data.

2. The image processing apparatus according to claim 1, wherein the distance measuring unit is configured to measure time required for returning a light beam reflected by the target object to generate the first distance data.

3. The image processing apparatus according to claim 1, further comprising:
a speed measuring unit configured to measure a moving speed of the distance measuring unit,
wherein the reliability calculating unit is configured to calculate the reliability based on the moving speed measured by the speed measuring unit.

4. The image processing apparatus according to claim 1, wherein the reliability calculating unit is configured to calculate the reliability based on at least one of luminance and color of the captured image.

5. The image processing apparatus according to claim 4, further comprising:
an extraction unit configured to extract area contour information relating to at least one of luminance and color of the captured image,
wherein the reliability calculating unit is configured to calculate the reliability based on the contour information.

6. The image processing apparatus according to claim 5, further comprising:
a correcting unit configured to generate third distance data by correcting the second distance data based on the contour information.

7. The image processing apparatus according to claim 6, wherein the correcting unit is configured to generate the third distance data by interpolating or extrapolating the second distance data based on the contour information.

8. The image processing apparatus according to claim 6, further comprising:
a virtual image generating unit configured to generate a virtual image based on position and orientation of the image acquisition unit using the third distance data and three-dimensional model information of a virtual object;
a combining unit configured to combine the captured image with the virtual image; and
a presenting unit configured to present a composite image.

9. The image processing apparatus according to claim 8, wherein the virtual image generating unit is configured to compare a Z buffer with the third distance data and determine a rendering area of the virtual object.

10. The image processing apparatus according to claim 8, wherein
the third distance data is a polygon constituted by three-dimensional points, and
the virtual image generating unit is configured to render the polygon as a transparent object.

11. The image processing apparatus according to claim 1, further comprising:
a direction measuring unit configured to measure a moving direction of the distance measuring unit,
wherein the reliability calculating unit is configured to calculate the reliability based on the moving direction.

12. The image processing apparatus according to claim 1, wherein the reliability calculating unit further comprises a detection unit configured to detect a difference area between a latest captured image and a preceding captured image, and the reliability calculating unit is configured to calculate the reliability based on the detected difference area.

13. The image processing apparatus according to claim 1, wherein the reliability calculating unit is configured to calculate the reliability based on a time-sequential change in at least one of position and shape of the target object included in the first distance data.

14. The image processing apparatus according to claim 1, wherein the reliability calculating unit comprises a detection unit configured to detect a difference between latest data and preceding data with respect to the first distance data, and the reliability calculating unit is configured to calculate the reliability based on the difference.

15. The image processing apparatus according to claim 1, wherein the first distance data is a two-dimensional range image that represents distance information obtained by the distance measuring unit.

16. The image processing apparatus according to claim 1, wherein the first distance data is a polygon constituted by three-dimensional points.

17. An image processing method for an image processing apparatus that comprises a distance measuring unit configured to measure a distance from a target object and generate first distance data, and an image acquisition unit configured to acquire a captured image including the object, the method comprising:
calculating a reliability level with respect to a measurement value of the first distance data based on at least one of the captured image and the first distance data; and
extracting a highly reliable area from the measurement value of the first distance data based on the calculated reliability and generating second distance data that is more reliable compared to the first distance data.

18. A non-transitory computer-readable storage medium storing a program that causes a computer to realize the image processing method according to claim 17.
